(19) United States
(12) Patent Application Publication
(10) Pub. No.: US 2025/0319694 A1
(43) Pub. Date: Oct. 16, 2025

(54) INKJET PRINTHEAD

(71) Applicant: 3C PROJECT MANAGEMENT LIMITED, Greystones, Co. Wicklow (IE)

(72) Inventor: Gregory John MCAVOY, Greystones, Co. Wicklow (IE)

(21) Appl. No.: 18/868,860

(22) PCT Filed: Jun. 13, 2023
(86) PCT No.: PCT/EP2023/065847

§ 371 Date: Nov. 25, 2024

(30) Foreign Application Priority Data
Jun. 13, 2022 (EP) 22178742.7

(51) Int. Cl. B41J 2/045; B41J 2/14; B41J 2/16

(52) U.S. Cl. CPC B41J 2/0455; B41J 2/04581; B41J 2/14233; B41J 2/161; B41J 2002/14491; B41J 2202/13; B41J 2202/22

(57) ABSTRACT

A printhead for ejecting one or more printable fluids, the printhead comprising a substrate defining a plurality of MEMS droplet ejectors arranged in a lattice, each comprising a flexible diaphragm, a piezoelectric actuator and at least one MEMS metallisation layer: the substrate further defines CMOS control circuitry comprising at least one CMOS metallisation layer and one or more of conductive connections in at least one said metallisation layer, extending from the CMOS control circuitry to each piezoelectric actuator to actuate the piezoelectric actuators: conductive connections extending through the lattice in at least one said metallisation layer to conduct actuator drive waveforms; and a plurality of bond pads in a discrete zone. The printhead is compact, can be easily fabricated and requires relatively few wired connections.

### FIELD OF THE INVENTION

The invention relates to the field of inkjet printheads formed as a monolithic structure on a substrate. Inkjet printheads eject printable fluids, such as coloured inks, materials for additive printing etc.

### BACKGROUND TO THE INVENTION

Conventional piezoelectric inkjet printheads with high densities of individual droplet ejectors formed on the same substrate require large numbers of individual wire connections, at least one per droplet. For a 1200 dpi inkjet printhead, this may equate to 1200 separate wire bonds to enable external, off-chip, connections

It has been proposed to provide an integrated piezoelectric inkjet printhead with CMOS drive circuitry formed on a substrate and overlaid with a MEMS layer comprising nozzles and MEMS piezoelectric transducers (WO2018/054917, McAvoy). This enables the number of external, off-chip, connections to be greatly reduced.

Furthermore, the devices may be formed using conventional CMOS foundry processes without additional assembly steps to join droplet ejector components.

It is desirable to maximise droplet ejector density, to minimise printing artefacts so that adjacent nozzles are subject to consistent physical parameters (temperature, pressure etc). As a result, on-chip wiring of individual droplet ejectors presents a technical problem and can limit maximum droplet ejector density. This is especially true in devices where nozzles are formed in the MEMS layer and ink chambers are defined at least in part by the substrate. In this case, the resulting holes through the substrate, and at least some of the surface area required for the piezoelectric transducers, are not available for routing electrical signals, limiting droplet ejector density.

The present invention addresses these issues and aims to provide a compact monolithic printhead which can be formed with a high density of droplet ejectors, typically using conventional CMOS foundry processes.

### SUMMARY OF THE INVENTION

A printhead for ejecting one or more printable fluids, the printhead comprising a substrate;
the substrate defining a plurality of MEMS droplet ejectors for ejecting droplets of the one or more printable fluids and arranged in a lattice, each droplet ejector comprising a flexible diaphragm and a piezoelectric actuator to eject a droplet of a (respective) printable fluid through a nozzle by causing movement of the flexible diaphragm, each droplet ejector comprising at least one MEMS metallisation layer;
the substrate further defining CMOS control circuitry comprising at least one CMOS metallisation layer.

The substrate may comprise conductive connections in at least one said metallisation layer (i.e. at least one said MEMS metallisation layer and/or at least one said CMOS metallisation layer), extending from the CMOS control circuitry to each piezoelectric actuator to actuate the piezoelectric actuators.

The substrate may comprise conductive connections extending through the lattice in at least one said metallisation layer (i.e. at least one said MEMS metallisation layer and/or at least one said CMOS metallisation layer) to conduct actuator drive waveforms.

The substrate may comprise a plurality of bond pads in a discrete (e.g. single) zone (e.g. along a single edge) of the substrate.

The substrate may comprise one or more of:
(i) conductive connections in at least one said metallisation layer (i.e. at least one said MEMS metallisation layer and/or at least one said CMOS metallisation layer), extending from the CMOS control circuitry to each piezoelectric actuator to actuate the piezoelectric actuators; and
(ii) conductive connections extending through the lattice in at least one said metallisation layer (i.e. at least one said MEMS metallisation layer and/or at least one said CMOS metallisation layer) to conduct actuator drive waveforms, optionally and/or
(iii) a plurality of bond pads in a discrete (e.g. single) zone (e.g. along a single edge) of the substrate.

The one or more printable fluids may comprise a plurality of printable fluids, typically at least three or at least four different printable fluids. The printable fluids may be inks. The inks may differ in colour. The printhead may be a multi-channel printhead. By this we refer to a printhead with a plurality of different printable fluids and/or a plurality of different lattices (droplet ejector zones), typically with separate printable fluid supplies.

The lattice may be a parallelogrammic lattice. The lattice may be a rhombic lattice, a hexagonal lattice, a rectangular lattice (for example a square lattice) or an equilateral triangular lattice. Thus, the plurality of MEMS droplet ejectors may be arranged in a grid.

The lattice of MEMS droplet ejectors typically forms a droplet ejector zone of the substrate. The droplet ejector zone typically comprises at least 100 droplet ejectors. The droplet ejector zone is typically elongate. The droplet ejector zone typically has a length and a width. The droplet ejector zone may be rectangular. The droplet ejector zone may be a parallelogram. Typically, the ratio of the length to the width of the droplet ejector zone is at least 5, or at least 10, or at least 20. By the length and width we refer to the length and width of the smallest area rectangle which would wholly encompass the droplet ejector zone.

Typically, the lattice comprises a plurality of rows of MEMS droplet ejectors extending across the width of the lattice. Typically, there are more rows (which extend across the width) than there are MEMS droplet ejectors in any row. Typically there are at 4 to 16, or more typically 8 to 12 MEMS droplet ejectors in each row (which extends across the width).

Typically the lattice comprises more than 50 rows (which are typically parallel to each other). The rows may be aligned parallel to the width of the droplet ejector zone. However, this is not essential, for example in the case of a parallelogramic lattice, the rows will not be aligned parallel to the width of the droplet ejector zone but at a slight angle. Typically, the rows extend at an angle of between 45° and 135° to the length of the droplet ejector zone, or between 30° and 120° to the length of the droplet ejector zone, or between 15 and 105° to the length of the droplet ejector zone.

It may be that the substrate comprises (i) conductive connections (actuation conductive connections) in at least one said metallisation layer, extending from the CMOS control circuitry to each piezoelectric actuator to actuate the piezoelectric actuators.

In some embodiments, there are one or more separate individual conductive connections extending from the CMOS control circuitry to each piezoelectric actuator to actuate each piezoelectric actuator individually. In other embodiments, one or more conductive connections to actuate the actuators are connected each of a plurality of piezoelectric actuators to actuate each piezoelectric actuator however in this case the CMOS control circuitry is typically configured to address control signals individually to each piezoelectric actuator.

Typically, the length of the actuation conductive connections, between the CMOS control circuitry and the piezoelectric actuators in a group of piezoelectric actuators is consistent. The actuation conductive connections are of similar length, thickness and breadth so that they are affected to a similar extent by voltage droop, parasitic capacitance, antenna effects etc.

It may be that the length of the conductive connections to actuate the piezoelectric actuators, between the CMOS control circuitry and the piezoelectric actuators within a droplet ejector zone, is consistent.

Typically, the length of the conductive connections to actuate the piezoelectric actuators, between the CMOS control circuitry (for example, an ejection transistor) and the piezoelectric actuators in a droplet ejector zone varies by no more than 1 cm, preferably no more than 0.1 cm. Typically, the length of the conductive connections to actuate the piezoelectric transducers, between the CMOS control circuitry and the piezoelectric actuators in a droplet ejector zone varies by no more than 10 times the spacing between droplet ejectors along a row of droplet ejectors. Typically, the substrate is elongate with a length and width and the length of the conductive connections to actuate the piezoelectric transducers, between the CMOS control circuitry and the piezoelectric actuators in a droplet ejector zone varies by no more than 20%, or no more than 10% of the width of the substrate. The droplet ejector zone typically comprises at least 8 droplet ejectors. The droplet ejectors of the droplet ejector zone typically eject the same one printable fluid of a plurality of printable fluids.

Typically, the conductive connections to actuate the piezoelectric actuators comprise metal wires which extend from the CMOS control circuitry in one or more CMOS metallisation layers, through a connection to one or more MEMS metallisation layers adjacent the respective piezoelectric actuator, and through the one or more MEMS metallisation layers to an electrode of the MEMS piezoelectric actuator.

The CMOS metallisation layers are metallisation layers which connect CMOS devices in the substrate and which are formed as part of a CMOS manufacturing process. The MEMS metallisation layers are metallisation layers which are formed (on top of the CMOS metallisation layers) and used for the purpose of operating the MEMS device. (In the present invention, the MEMS metallisation layers may also comprise additional conductors, for example conductive connections to conduct actuator drive waveforms). One or more of the piezoelectric transducer, the electrodes and the MEMS metallisation layers may comprise gold. Gold is excluded from CMOS manufacturing facilities.

The lattice of MEMS droplet ejectors may form a droplet ejector zone of the substrate, the droplet ejector zone being elongate with a length and a width and with opposite long sides along the length, wherein the conductive connections to actuate the actuators extend into the lattice, from one or two of the opposite long sides of the droplet ejector zone.

Typically, the conductive connections extend into the lattice with a length which is less than 1.5 times and typically less than 1.2 times the width of the droplet ejector zone. In some embodiments, the conductive connections extend into the lattice with a length which is less than the width of the droplet ejector zone

The CMOS control circuitry may comprise a plurality of drive transistors at least one of which is connected directly to at least one electrode of the piezoelectric transducer of each MEMS droplet ejector by a said conductive connection to actuate the piezoelectric actuators, without intervening transistors, wherein the plurality of drive transistors are arranged in at least one row adjacent the one or two opposite long sides of the droplet ejector zone.

It may be that the conductive connections to actuate the piezoelectric actuators extend into the lattice between rows of MEMS droplet ejectors.

Typically, the conductive connections to actuate the piezoelectric actuators extend into the lattice between rows of MEMS droplet ejectors from one or both opposite long sides. Typically, conductive connections to actuate the piezoelectric actuators extend widthwards into the lattice between rows of MEMS droplet ejectors.

This arrangement ensures that MEMS droplet ejectors within the same row (parallel to the width) receive control signals from the control circuitry at very similar times. This improves print quality and/or reduces control complexity.

Typically, the aspect ratio of the length to the width (of the lattice/droplet ejector zone) is at least 5 or at least 10 or at least 20.

It may be that conductive connections to actuate the piezoelectric actuators extend into the lattice, from one or both long sides. Where the conductive connections to actuate the piezoelectric actuators extend into the lattice from both long sides, along the width.

It may be that the rows of piezoelectric actuators between which the conductive connections to actuate the piezoelectric transducers extend, are aligned at an angle of at least 45,° and typically at least 60° or at least 75° to the length of the droplet ejector zone.

It may be that the actuator drive waveforms comprise pulses with portions at each polarity. Thus, the direction of the potential difference across each piezoelectric actuator reverses twice within each droplet ejection.

It may be that the CMOS control circuitry is configured to determine, for each MEMS droplet ejector, for each of a plurality of ejection cycles, whether or not that MEMS droplet ejector should eject a droplet, wherein the conductive connections to actuate the actuators are connected to ejector switches (typically latches) associated with each MEMS droplet ejector to thereby control whether each individual MEMS droplet ejector does or does not eject a droplet.

Thus, a determination whether each MEMS droplet ejector should eject a droplet is made in the CMOS control circuitry (typically in response to digital image data received through a digital interface, typically the one or more bond pads). This avoids a requirement for large numbers of individual conductive connections to control circuitry which is external to the substrate, thereby reducing the difficulty of connecting the substrate. Typically a decision is made for each MEMS droplet ejector for each of the plurality of ejection cycles. An ejection cycle may comprise a plurality of phases during each of which a different subset of MEMS droplet ejectors eject printable fluid, if selected.

The substrate may comprise (ii) conductive connections extend through the lattice in at least one said metallisation layer to conduct actuator drive waveforms, to connect the MEMS droplet ejectors to one or more sources of actuator drive waveforms.

It may be that the conductive connections connect different groups of MEMS droplet ejectors to different ones of a plurality of sources of actuator drive waveforms, to thereby relay different actuator drive waveforms to different groups of MEMS droplet ejectors.

Typically the MEMS droplet ejectors comprise a plurality of spatially separate MEMS droplet ejector zones, each comprising a lattice of MEMS droplet ejectors and each MEMS droplet ejector in the same droplet ejector zone receives the same actuator drive waveform. Typically, for at least two, or at least four, different droplet ejector zones, the droplet ejectors in each zone receive a different actuator drive waveform. Typically, the droplet ejectors in each zone receive printable fluid from the same source. Thus, droplet ejectors which eject different printable fluids may receive different actuator drive waveforms, while those droplet ejectors which eject the same printable fluid may be located in the same droplet ejector zone and receive the same actuator drive waveform. Thus, the actuator drive waveforms can be customised depending on the physical properties of each printable fluid.

The sources of actuator drive waveforms may comprise one or more actuator drive waveform generators. The sources of actuator drive waveforms may comprise one or more interfaces, such as bond pads of the printhead substrate, typically the said plurality of bond pads, for receiving actuator drive waveforms from a source which is external to the substrate. The external source may for example be one or more actuator drive waveform generators which are not formed on the substrate, and typically are separate to the printhead but located within print apparatus, such as a printer, which also comprises the printhead.

It may be that the droplet ejector zone has a length and a width, and with opposite long sides along the length, wherein the conductive connections to conduct actuator drive waveforms extend into the lattice, from one or two of the opposite long sides of the droplet ejector zone.

It may be that conductive connections to conduct actuator drive waveforms extend into the lattice, from one or both opposite long sides. It may be that conductive connections to conduct actuator drive waveforms extend into the lattice between rows of MEMS droplet ejectors, from one or both opposite long sides. It may be that conductive connections to conduct actuator drive waveforms extend widthwards into the lattice, between rows of MEMS droplet ejectors.

It may be the rows of piezoelectric actuators between which the conductive connections to conduct actuator drive waveforms extend, are aligned at an angle of at least 45,° and typically at least 60° or at least 75° to the length of the droplet ejector zone.

It may be that the substrate defines a plurality of elongate droplet ejector zones and the conductive connections to conduct actuator drive waveforms comprise a plurality of separate buses, wherein for one or more of the elongate droplet ejector zones, conductors which are part of the bus to conduct actuator drive waveforms to that zone extends across the width of one or more further droplet ejector zones.

Thus the conductive connections to conduct actuator drive waveforms do not need to extend around the (short) edges of each droplet ejector zone, reducing their length and enabling more substrate surface area to be used than if they instead extended around the (short) edge of each droplet ejector zone.

It may be that the substrate comprises (iii) a plurality of bond pads in a single discrete zone of the substrate.

The substrate may comprise a bond pad zone, comprising a plurality of bond pads, which is spatially separate from the plurality of MEMS droplet ejectors and typically also spatially separate from the CMOS control circuitry. There may be only a single bond pad zone. The bond pad zone may be elongate and arranged along a single edge of the substrate. Typically the substrate is elongate with opposing long edges, with short edges therebetween and the bond pad zone is arranged along a long edge. However, in some embodiments, the bond pad zone may be on a short edge. There may be two bond pad zones which are elongate and typically also arranged along opposite long sides of the substrate. The bond pads within a or the bond pad zone May be spaced apart along a straight line.

The substrate may comprise, in total, fewer than 75 or even fewer than 50 external electrical connections. The ratio of individually controllable MEMS droplet ejectors to external electrical connections may be greater than 1, greater than 10 or in some embodiments greater than 100. This is enabled by the CMOS control circuitry and reduces the complexity of the wiring connections to the substrate in comparison to printing apparatus requiring a separate electrical connection for each individually controllable MEMS droplet ejector on the substrate.

It may be that one or more conductive connections for actuator drive signals is configured to switchedly provide a potential to 100 or more, or even 1000 or more droplet ejectors. It may be that the conductive connections extending from the CMOS drive circuitry to the piezoelectric actuators to actuate the piezoelectric actuators each provide a potential to 10 or fewer, 4 or fewer, or only one piezoelectric actuator. Thus, they may require a much lower cross section of conductive metal than the conductive connections for actuator drive signals.

It may be that there are no transistors within the lattice of MEMS droplet ejectors.

However, it may be that, for at least the majority of the plurality of MEMS droplet ejectors, an ejector switch comprising one or more CMOS transistors formed on the substrate, is located within the lattice in electronic communication with one or more said conductive connections (conductive connections to actuate the piezoelectric actuators and/or conductive connections to conduct actuator drive waveforms and/or conductive connections to connect each of the MEMS droplet ejectors to two or more different fixed voltages), to controllably cause a potential difference to be applied to the electrodes of the piezoelectric actuator of the respective MEMS droplet ejector and cause printable fluid ejection by the MEMS droplet ejector. The ejector switch typically comprises a latch.

It may be that the ejector switch is configured to selectively route an actuator drive waveform (voltage and/or current) to the respective piezoelectric transducer, the actuator drive waveform being received through one or more said conductive connections in at least one metallisation layer.

Thus, the power electronics required to generate the current for the piezoelectric transducers can be located elsewhere, and the associated heat generated elsewhere.

In some embodiments, the ejector switch requires only to switch the actuator drive waveform, reducing power consumption on the substrate, within the lattice.

Typically, the CMOS control circuitry is located in one or more discrete zones of the substrate, separate to the bonds pads and MEMS droplet ejectors.

Nevertheless, in some embodiments the ejector switches may be located within the lattice for at least the majority of the plurality of MEMS droplet ejectors. In other embodiments, one or more transistors which function as ejectors switches for individual respective MEMS droplet ejectors are located within the CMOS control circuitry. Thus, it may be that there are no transistors, or at least fewer transistors than MEMS droplet ejectors, within the lattice of MEMS droplet ejectors.

It may be that each MEMS droplet ejector includes a hole through the substrate for ejection of printable fluid.

Thus, the substrate comprises a plurality of holes, each associated with a corresponding one of the MEMS droplet ejectors. The holes typically form a lattice. The holes are typically nozzles for the MEMS droplet ejectors. Typically each nozzle is in fluid communication with a printable fluid chamber defined at least in part by the substrate.

Because each MEMS droplet ejector includes a hole through the substrate, the surface area of substrate available for conductive connections is limited. Typically, the conductive connections extend in between rows of holes.

Typically, each flexible diaphragm extends around a corresponding hole. The conductive connections may extend in between flexible diaphragms, without overlap with the flexible diaphragms. The conductive connections may extend in between holes, without overlap with the central 50% by surface area of the flexible diaphragms.

It may be that, in at least a region of the substrate (typically at least a region of the substrate within the lattice of droplet ejectors, for example adjacent each droplet ejector), the one or more MEMS metallisation layers overlie the one or more CMOS metallisation layers.

One or more MEMS metallisation layers may be formed directly over the one or more CMOS metallisation layers.

It may be that one or more CMOS metallisation layers is integrated with one or more MEMS metallisation layers, for example, at an interface of the CMOS control circuitry.

Thus, one or more CMOS metallisation layers and one or more metallisation layers may be formed concurrently.

One or more CMOS metallisation layers may be electrically connected to one or more MEMS metallisation layers.

One or more insulation layers may be formed between the one or more CMOS metallisation layers and the one or more MEMS metallisation layers. Typically, the said one or more insulation layers is thicker than the insulation layers between the CMOS metallisation layers. This provides additional electrical insulation and decreases parasitic capacitance between metal wiring layers.

It may be that the substrate further comprises conductive connections extending through the lattice in at least one metallisation layer to connect each of the MEMS droplet ejectors (typically the ejector switch of each MEMS droplet ejector) to two or more different fixed voltages, wherein the CMOS control circuitry (typically the ejector switch associated with each MEMS droplet ejector) is configured to selectively connect at least one electrode of the piezoelectric actuator of the respective droplet ejector to each of a plurality of the two or more different fixed voltages in turn, responsive to control signals from the CMOS control circuitry.

It may be that the droplet ejector zone has a length and a width, and with opposite long sides along the length, wherein the conductive connections to connect each of the MEMS droplet ejectors to two or more different fixed voltages extend into the lattice, from one or two of the opposite long sides of the droplet ejector zone.

It may be that conductive connections to connect each of the MEMS droplet ejectors to two or more different fixed voltages extend into the lattice, from one or both opposite long sides. It may be that conductive connections to connect each of the MEMS droplet ejectors to two or more different fixed voltages extend into the lattice between rows of MEMS droplet ejectors, from one or both opposite long sides. It may be that conductive connections to connect each of the MEMS droplet ejectors to two or more different fixed voltages extend widthwards into the lattice, between rows of MEMS droplet ejectors.

It may be the rows of piezoelectric actuators between which the conductive connections to connect each of the MEMS droplet ejectors to two or more different fixed voltages extend, are aligned at an angle of at least 45,° and typically at least 60° or at least 75° to the length of the droplet ejector zone.

It may be that the substrate defines a plurality of elongate droplet ejector zones and the conductive connections to connect each of the MEMS droplet ejectors to two or more different fixed voltages comprise a plurality of separate buses, wherein for one or more of the elongate droplet ejector zones, conductors which are part of the bus to conduct actuator drive waveforms to that zone extends across the width of one or more further droplet ejector zones.

Thus the conductive connections to connect each of the MEMS droplet ejectors to two or more different fixed voltages do not need to extend around the (short) edges of each droplet ejector zone, reducing their length and enabling more substrate surface area to be used than if they instead extended around the (short) edge of each droplet ejector zone.

It may be that one or more conductive connections to connect each of the MEMS droplet ejectors to two or more different fixed voltages is configured to switchedly provide a potential to 100 or more, or even 1000 or more droplet ejectors.

It may be that the ejector switch is configured to selectively connect a respective piezoelectric transducer to two or more (or three or more) different fixed voltages in turn to actuate a droplet ejection, the piezoelectric transducer being connected to the different fixed voltages through one or more said conductive connections in at least one metallisation layer.

It may be that the printhead comprises a first plurality of conductive connections and a second plurality of conductive connections, wherein the one of the first and second plurality of conductive connections comprises the conductive connections to actuate the piezoelectric actuators and the other of the first and second plurality of conductive connections comprises conductive connections to conduct droplet ejector waveforms or a plurality of different potentials, and wherein at one or more locations within the lattice, at least one first conductive connection and at least one second conductive connection both extend. Typically, they extend in different metallisation layers.

The said at least one first and at least one second conduction connection may be parallel. The said at least one first and at least one second conduction connection May cross each other.

Typically, the at least one conductive connection to conduct a droplet ejector waveform is located within a MEMS metallisation layer and at least one conductive connection to actuate the piezoelectric actuators is located within a CMOS metallisation layer.

Typically, one of the first and second plurality of conductive connections extends through one or more MEMS metallisation layers and the other of the first and second plurality of conductive connections extends through one or more CMOS metallisation layers.

It may be that conductors to conduct actuation signals to the droplet ejectors extend between rows of droplet ejectors such that they overlap but are located in different metallisation layers, e.g. different CMOS metallisation layers. This enables a larger number of droplet ejectors to be individual addressed from one side of a droplet ejector zone.

It may be that, at one or more locations within the lattice, at least one conductive connection to actuate the piezoelectric actuators and at least one conductive connection to conduct a droplet ejector waveform, extend (typically in parallel) between the same adjacent rows of droplet ejectors.

It may be that the lattice comprises at least a first, a second and a third row of MEMS droplet ejectors (typically without other rows in between) wherein a plurality of (and typically at least four) conductive connections extend between droplet ejectors of the first and second row to different respective droplet ejectors along the length of the second row, typically wherein a plurality of (and typically at least four) conductive connections extend between droplet ejectors of the second and third row to different respective droplet ejectors along the length of the second row.

The plurality of (typically at least four) conductive connections extending between rows of droplet ejectors to different respective droplet ejectors may extend through the same, or different, metallisation layers.

It may be that the CMOS control circuitry comprises one or more first zones and one or more second zones, wherein the substrate comprises one or more isolation features separating the first and second zones, wherein the one or more first zones comprise transistors which process digital signals and the one or more second zones comprise drive transistors which provide potentials directly to the electrodes of piezoelectric actuators, wherein the second zone operates at at least double the maximum potential of the first zone.

It may be that the CMOS control circuitry is formed on a first surface of the substrate and wherein the flexible diaphragms, piezoelectric actuators and MEMS metallisation layers are also formed on the first surface of the substrate.

The first surface of the substrate typically comprises a nozzle-forming layer which comprises the flexible diaphragms and piezoelectric actuators.

It may be that the substrate defines a plurality of adjacent droplet ejector zones which are elongate having a length and a width and which are spaced apart orthogonally to their length, wherein between each adjacent droplet ejector zone there is provided at least one CMOS circuitry zone which is also elongate and aligned in the same orientation as the droplet ejectors zones, the CMOS circuitry zone including at least one CMOS metallisation layer, wherein conductive connections extend from the CMOS circuitry into adjacent droplet ejector zones to actuate piezoelectric actuators.

Typically, the substrate is elongate (typically rectangular) and the droplet ejector zones have a length and width aligned with the length and width of the substrate.

It may be that the at least one CMOS circuitry zone comprises both a higher and a lower voltage region, the lower voltage region comprising one or more digital logic gates, the higher voltage region comprising ejection transistors which are directly connected to the piezoelectric transducers of respective droplet ejectors.

Typically, the higher and lower voltage regions are separate by an isolation feature in the substrate.

By higher and lower voltage regions we refer to the relative voltage during operation.

It may be that one or more conductive connections for actuator drive waveforms extend widthwise across one or more droplet ejector zones and connect to a higher voltage region of a CMOS circuitry zone.

The invention extends in a second aspect to printing apparatus comprising a printhead according to the first aspect of the invention.

According to a third aspect of the invention there is provided a method of forming a printhead according to any one preceding claim, comprising the steps of:
forming a lattice of apertures through a substrate, each aperture to at least in part define a fluid chamber of a droplet ejector;
forming the CMOS control circuitry, including at least one CMOS metallisation layer, on a first surface of the substrate;
forming a MEMS layer, comprising flexible diaphragms, piezoelectric actuators and at least one MEMS metallisation layer, on the first substrate of the substrate, to thereby form the plurality of droplet ejectors;
whereby each droplet ejector is conductively connected to the CMOS control circuitry through at least one said metallisation layer.

The method may comprise forming an insulating layer over the CMOS control circuitry before the step of forming at least one MEMS metallisation layer.

The MEMS layer may have holes therein. The holes may function as the nozzles of the droplet ejectors.

### DESCRIPTION OF THE FIGURES

An example embodiment of the present invention will now be illustrated with reference to the following Figures in which:

FIG. 1 is a plan view of an integrated inkjet printhead;

FIG. 2 is a schematic diagram of control circuitry within and external to the printhead;

FIG. 3 is a plan view of electrode drive conductors extending through the lattice of droplet ejectors;

FIG. 4 is a cross-section through a region of integrated inkjet printhead;

FIG. 5 is a plan view of rows of 8 actuators being connected to respective drive circuitry on either side of those rows, through electrode drive conductors which extend into the lattice from opposite long sides;

FIG. 6 is a plan view of an embodiment in which rows of 8 actuators are connected to drive circuitry arranged along a single side of the rows;

FIG. 7 is a plan view of selected components from a portion of the printhead at the left side of FIG. 1;

FIGS. 8 and 9 are plan views of electrical connections extending across a lattice of droplet ejectors;

FIG. 10 is a plan view of conductors extending across a plurality of lattices of droplet ejectors of different channels;

FIG. 11 is a cross-section through a printhead substrate according to the invention;

FIG. 12 is a cross-section through a printhead substrate according to FIG. 3 along a lengthwise cross-section extending between two actuator drive waveform conductors;

FIGS. 13 and 14 correspond to FIGS. 3 and 11 for an alternative cross-section through a substrate;

FIG. 15 is a flow charge of a method of manufacturing a printhead module.

### DETAILED DESCRIPTION OF AN EXAMPLE EMBODIMENT

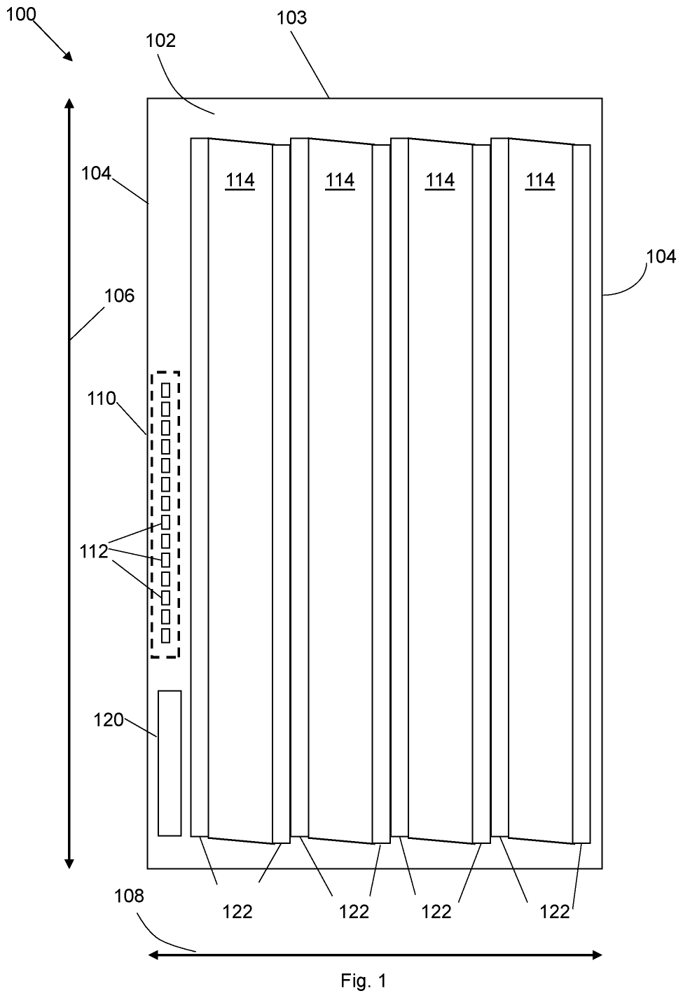

FIG. 1 is a plan view showing the layout of an integrated inkjet printhead 100. The printhead is formed on a single semiconductor substrate 102 and is elongate with opposite long edges 104 parallel to its length 106 and opposite short edges 103 parallel to its width 108. A bond pad zone 110 comprising a plurality of bond pads 112 is arranged along part of a single long edge. The substrate has a plurality of elongate zones of integrated droplet ejectors 114A, 114B, 114C, 114D, each relating to a different channel and aligned with the long edges of the substrate and so extending lengthwise. Each zone comprises droplet ejectors having the same printable fluid supply. In this example, each zone of integrated droplet ejectors has a different colour printable fluid supply although the invention is applicable to multi-channel devices with single colour or single type printable fluid supplies. Within each zone, the droplet ejectors are arranged in a lattice (a repeating array of points e.g. a rhombic lattice, a square lattice, a hexagonal lattice, a rectangular lattice, a parallelogrammic lattice, an equilateral triangular lattice). In this example, the droplet ejectors are arranged in a parallelogrammic lattice having columns extending parallel to the length of the substrate (lengthwise) and rows extending across the width of the lattice, at a slight angle to the width of the lattice (widthwise). Rows of droplet ejectors extend widthwise across each zone of droplet ejectors, at a small angle to the long edges and to the length of the droplet ejector zones. This parallelogrammic arrangement provides droplet ejectors at a wide range of longitudinal positions increasing maximum print density.

The substrate is a semiconductor substrate with CMOS control circuitry formed thereon. The CMOS control circuitry comprises central control circuitry 120 (master data path circuit) which carries out calculations and determines signal routing, and also drive circuitry 122, comprising at least one CMOS drive transistor for each droplet ejector. The drive circuitry functions as latches and provides wired connections to the electrodes of a piezoelectric actuator in each droplet ejector. Elongate zones of drive circuitry 122 are arranged along and also interposed between opposite long sides of each zone of droplet ejectors and are configured to controllably actuate the droplet ejectors in each zone of droplet ejectors, such that individual rows of droplet ejectors are actuated by drive transistors at either end of the row, using conductive connections 240 extending into the lattice of droplet ejectors from opposite long sides.

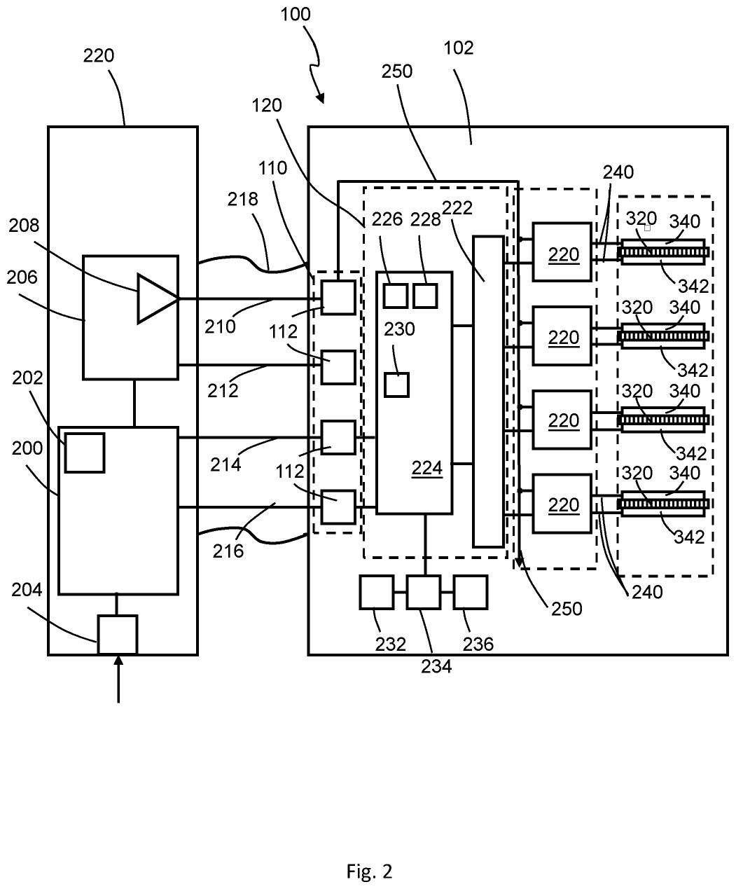

FIG. 2 is a schematic diagram of the control circuitry for a printhead assembly. In this example, control of the printhead is distributed between a machine controller 220, which is separate to the substrate, and the control circuitry (e.g., CMOS circuit) 120, 122A-D on the substrate 102. They are connected in part by conductors extending through a single or multiple flexible cable interconnects 218.

Individual piezoelectric actuators 320 within droplet ejectors are controlled by the application of potentials to their electrodes 340, 342. These potentials are typically time-varying in the form of an actuator drive waveform which typically repeats for each droplet ejection cycle. The machine controller comprises at least a processor 200, such as a microprocessor or microcontroller which has memory 202 storing relevant data and program code. A wired or wireless electronic interface 204 receives input data from an external device driver. One skilled in the art will appreciate that the machine controller may be distributed between a number of separate components or functional modules, such as one component which converts an image into a pixelated pattern for printing using a dither matrix, for example, and a separate component which converts the pixelated pattern into a print pattern for the different nozzles.

The machine controller may comprise at least one waveform generator and a voltage amplifier 208 which provides a continuous pattern of actuator control pulses to the printhead through one or more drive signal conductors 210. A ground conductor 212 also extends from the machine controller to the substrate. (Ground connections on the substrate are not shown for clarity). The processor 200 generates digital control signals 214 typically as a serial bus, and also transmits clock signals 216 to the printhead which serve to synchronise printing with movements of the printhead. The connector also provides voltage levels associated with the operational voltage of CMOS control electronics.

On the substrate 100, bond pads 112 are connected to the conductors of the flexible connector and signals are routed from the bond pads through metallisation layers to the CMOS control circuit 120 and from the CMOS control circuit to the electrodes 320, 340 which actuate individual piezoelectric bodies 342 within respective droplet ejectors. The received signals includes both digital control signals encoding image information and the analogue actuator control pulses which are conducted through actuator drive waveform conductors 250.

The control circuit 120 on substrate 102 extends to the drive circuitry 122 which comprises ejection switch circuit 220, including ejection transistors having outputs which are in direct electrical connection with the electrodes 340, 342 (i.e. without a further intervening switching semiconductor junction) through electrode drive conductors 240, being conductive connections directly connected to the electrodes.

The ejection switch circuit selectively switches the actuator control pulse signals received through conductor 250 to apply these pulses signals to the respective electrodes through electrode drive conductors 240. If one of the electrodes remains connected to ground, the ejection switch circuit may be as simple as a single transistor per actuator, or a single transistor per electrode to switch the signal applied to that electrode and there may be a single electrode drive conductor 240 extending to the individual piezoelectric actuator, although in the example shown there are two conductors extending to each individual piezoelectric actuator, one per electrode.

The ejection switch circuit does not carry out power amplification. Instead it switches the actuator control pulses, determining whether each pulse is relayed to the respective actuator or not, for each pulse. Voltage amplification is carried out in the machine controller by amplifier 208.

The ejection switch circuit is controlled by latch and shift transistors 222, which receive and store digital data from a control circuit 224 which processes received data, for example converting received serial data, storing these in registers 226 and using the received data to determine which actuators are to actuate during each successive actuator firing events. The control circuit 228 also stores trim data used to customise the precise timing of voltage switching for each actuator, which is typically determined during a calibration step on set-up, and may store configuration data 230 which indicates the physical layout of nozzles, security information and or nozzle actuation count history information. The control circuit 224 also receives data from sensors 232, 234, 236, some of which are associated with individual actuators, for example nozzle fill levels sensors, and some of which sense parameters relevant to the function of the printhead as a whole, for example temperature sensors.

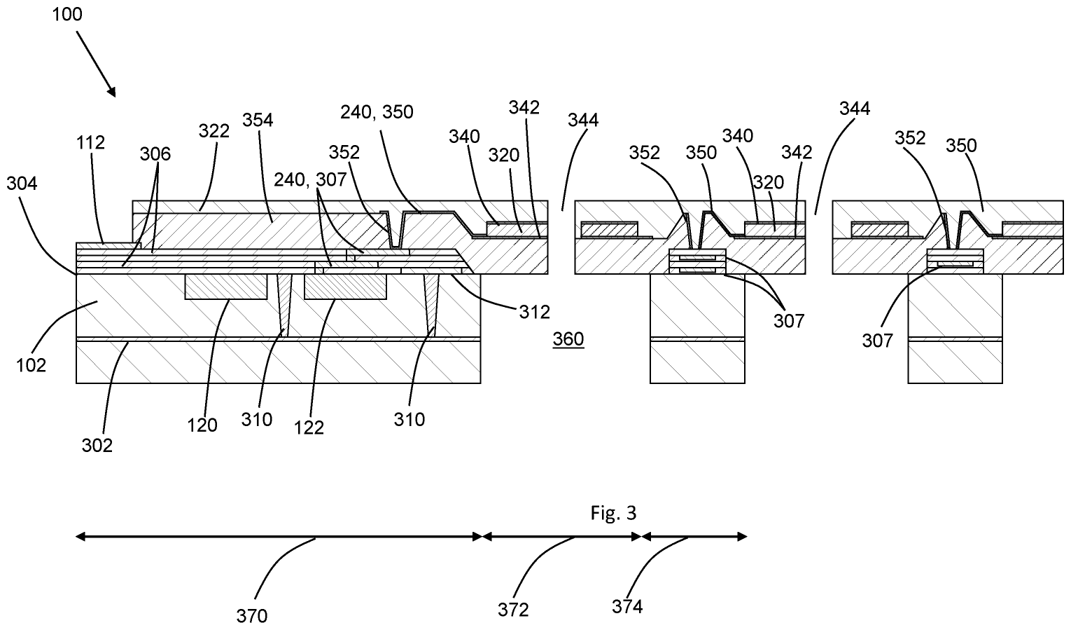

FIG. 3 is a cross-section through a region of integrated inkjet printhead 100, which comprises a silicon substrate 102, having an insulator layer 302 (thus being a silicon-on-insulator or silicon-on-insulator-on-silicon substrate). Integrated CMOS circuitry 120, 122 is formed in the first surface 304 of the silicon substrate with overlying CMOS metallisation layers 306 and intervening passivation layers 308, such as SiO₂, SiN, SiON. The person skilled in the art will appreciate that a CMOS circuit comprises both doped regions of the substrate and the metallisation layers within which interconnections are formed on the first surface of the substrate. The number of CMOS metallisation layers is variable but will typically be at least three.

The CMOS circuitry is divided into the central control circuitry 120 which is digital and operates at a standard CMOS digital logic voltage, such as 5V and the drive circuitry 122 which processes digital logic signals and switches analogue signals, particularly the actuator control pulse signals and so operates at a higher voltage than the central control circuitry. The CMOS circuits operating at the two different voltage levels are separated by deep trench isolation (DTI) barriers 310. A cross connector 312 extends across a DTI barrier to connect the ejection transistors in the drive circuitry 112 to the electrode drive conductors 240 which extend into the lattice of droplet ejectors. Bond pads 112 are formed on the substrate and communicate predominantly with the central control circuitry through paths in the CMOS metallisation layers to process digital signals, however one or more bond pads conduct the analogue actuator control pulse signals to the drive circuitry.

The printhead further comprises piezoelectric actuators comprising a piezoelectric body 320 which in this example is formed of AlN or ScAlN but may be formed of another suitable piezoelectric material which is processable at a temperature of below 450° C., to enable it to be deposited without damage to the underlying CMOS structures. The piezoelectric actuator 320 forms a diaphragm with layers of materials such as silicon, silicon oxide, silicon nitride or derivatives thereof and has a passivation layer 322 (sometimes referred to as a nozzle defining layer 322) which prevents applied electrical potentials from contacting fluid. Thus a MEMS layer, 320, 322, 323, 340, 342, 350, 352, 362 overlies CMOS layer 120, 122, 306, 307, 312 with the MEMS layers and CMOS layers being formed integrally.

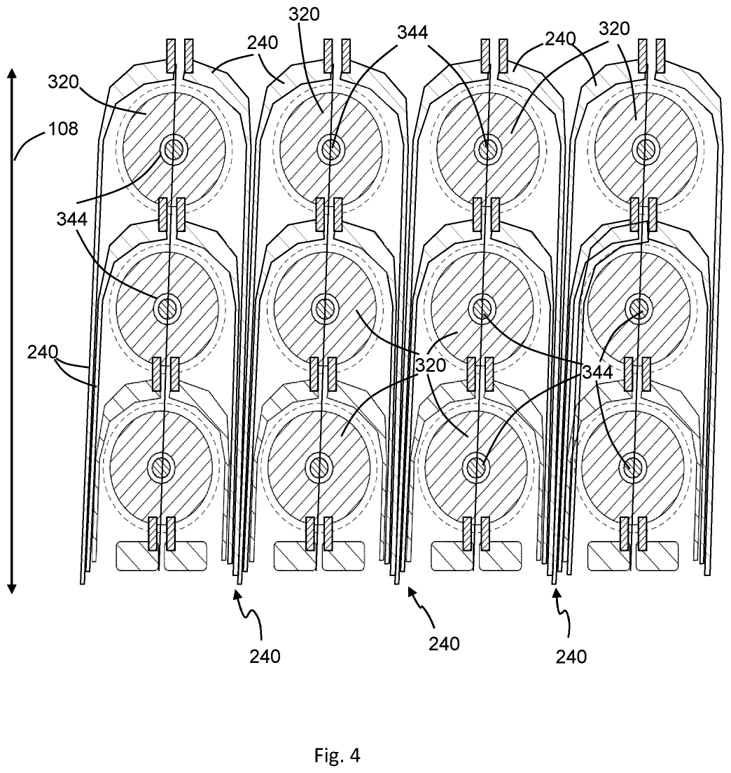

The CMOS metallisation layers 306 include interconnects, conducting external signals, signals with the central control circuitry, and within the drive circuitry. The drive circuitry is configured to apply a potential difference in use to piezoelectric actuator electrodes 340 and 342, through the CMOS metallisation layers 306 and a connection to one or more MEMS metallisation layers 350, adjacent the droplet ejectors. In this example, the MEMS metallisation layer shown connects to the CMOS metallisation layers through a via 352 extending through a passivation layer 354 between the MEMS structures and the CMOS metallisation layers. The electrode drive conductor 240 extending to one of the electrodes 342 shown in FIG. 4 is formed in part by MEMS metallisation layer 350 and conductive tracks 307 in CMOS metallisation layers.

The piezoelectric actuator 320 and passivation layers 322, 323, 354 defines a wall of a fluid chamber 360 which receives print agent, such as ink (in the case of an inkjet printer) or another printable fluid (for example in the case of an additive manufacturing printer) through a conduit (not shown). In operation, the piezoelectric actuator flexes when a droplet ejection voltage waveform is applied and ejects fluid through a respective nozzle 344.

It can be seen that the semiconductor cross-section comprises distinct zones. Zone comprises both CMOS and MEMS metallisation (and metal wiring) and CMOS transistors. Zone 372 comprises only MEMS metallisation, without CMOS metallisation or transistors. Zone 374 comprises both CMOS and MEMS metallisation (and metal wiring), but no CMOS transistors.

This actuator configuration is compact and energy efficient but the presence of holes (the chambers and nozzles) and the flexible regions (the piezoelectric actuators) limits the surface area which is available to route conductive connections and therefore can limit nozzle density.

Referring again to FIG. 1, the ejection switch circuits are extended along the long sides of the elongate lattices of droplet ejectors and the electrode drive conductors from the ejection transistors to the electrodes extend into the lattices of droplet ejectors from either side, such that the connections from the ejection transistors to the electrodes are short (less than the width of the elongate lattice) and of similar length to each other.

With reference to FIG. 4, the electrode drive conductors 240 extend from the driver transistors into the lattice of droplet ejectors along rows, between piezoelectric actuators 320. (Note that FIG. 4 is rotated by 90° relative to FIG. 1, the width 108 is shown for reference). It can be seen from FIG. 4 that if the droplet ejector density is to be as high as possible there is very limited space available in a single two dimensional plane for the electrode drive conductors 240, due to the presence of nozzles 344, which are essentially holes through the substrate and also due to a desire to avoid the piezoelectric actuators 320, although in practice a limited amount of overlap with the actuators may be possible.

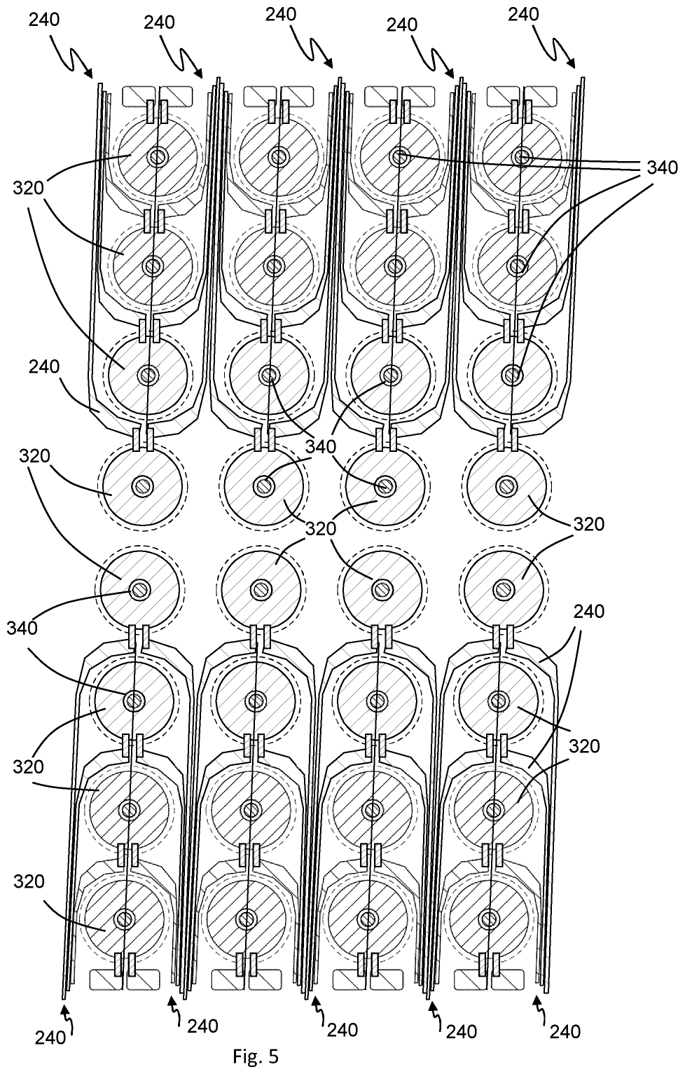

FIG. 5 is a plan view of rows of 8 actuators being connected to respective drive circuitry 122 on either side of those rows, through electrode drive conductors 240 which extend into the lattice from opposite long sides.

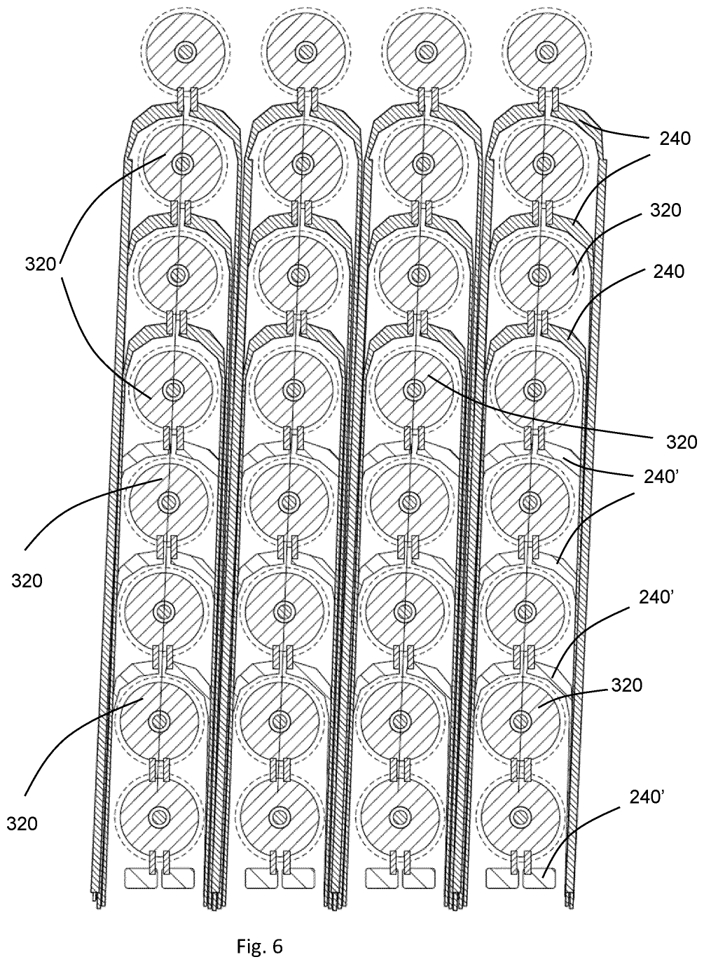

FIG. 6 is a plan view of an embodiment in which rows of 8 actuators are connected to drive circuitry 122 arranged along a single side of the rows. Different regions of electrode drive conductor 240, 240′ are arranged in two different CMOS metallisation layers (e.g. M3 and M1). In this plan view the electrode drive conductors in the layer further from the substrate 240 overlie and so partially obscure the conductors closer to the substrate 240′.

In these arrangement, electrode drive conductors (the conductive connections to actuate the piezoelectric actuators) are relatively short and of consistent length. Accordingly, they actuate the piezoelectric actuators at consistent times. Each electrode drive conductor can be shorter than 1.5 times the width of the droplet ejector zone, or even shorter than the width of the droplet ejectors zone. There is no requirement for electrode drive conductors to extend around the edges of the droplet ejectors zones, which would take up space on the substrate, reducing overall nozzle density and leading to variability in the timing of actuation signals.

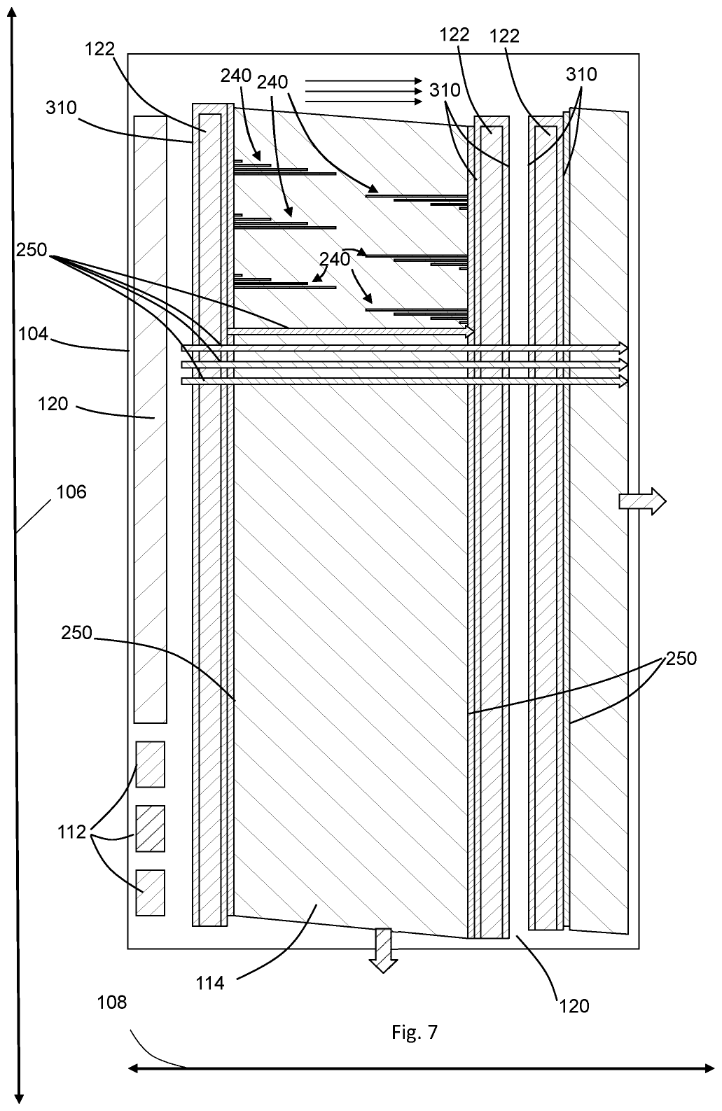

FIG. 7 is a plan view of selected components from a portion of the printhead at the left side of FIG. 1. A long edge of the substrate comprises bond pads 112 and main CMOS control circuit zone 120 used for timing control, decoding and distributing data etc. A first nozzle zone 114 comprising a lattice of droplet ejectors is located between elongate zones of drive circuitry 122, comprising high voltage transistor circuits surrounded by DTI isolation pockets 310. Strips of CMOS digital control logic 121, being part of the CMOS control circuit zone, extend between strips of drive circuitry.

The actuator drive waveform conductors 250 are arranged as a two-dimensional grid, extending up each elongate zone of drive circuitry and across droplet ejector zones. A relatively large surface area of these drive waveform conductors is required due to the current which may pass through them in operation and the grid of multiple parallel drive waveform conductors efficiently distributes the waveform signals. It can be seen that some actuator drive waveform conductors 250 extend (widthwise) through the lattice of droplet ejectors parallel to, but in a different metallisation layer to, the electrode drive conductors 240 (connections to three rows only shown for clarity).

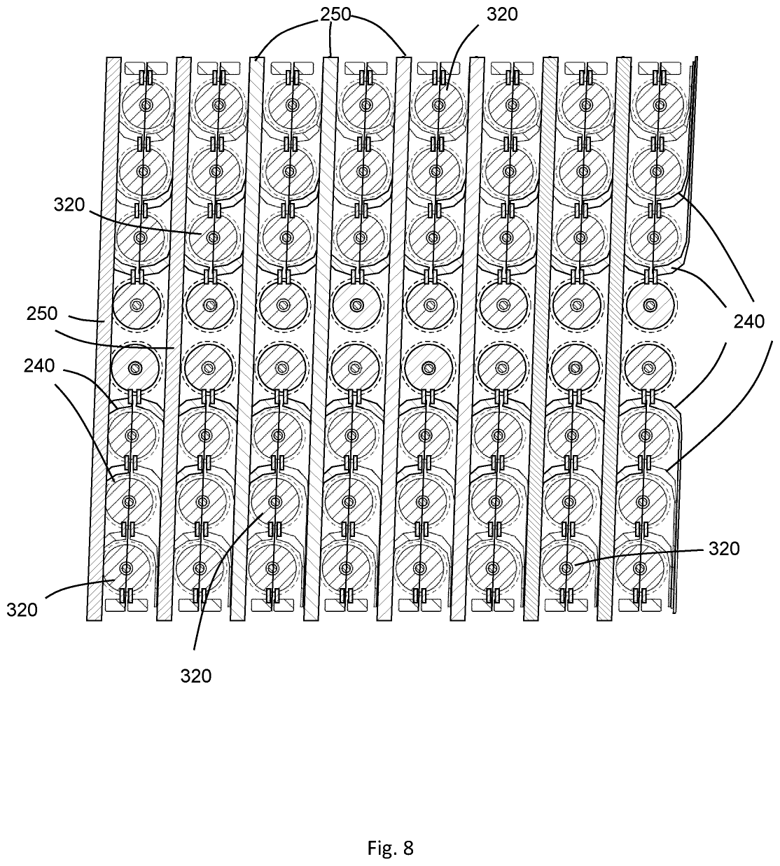

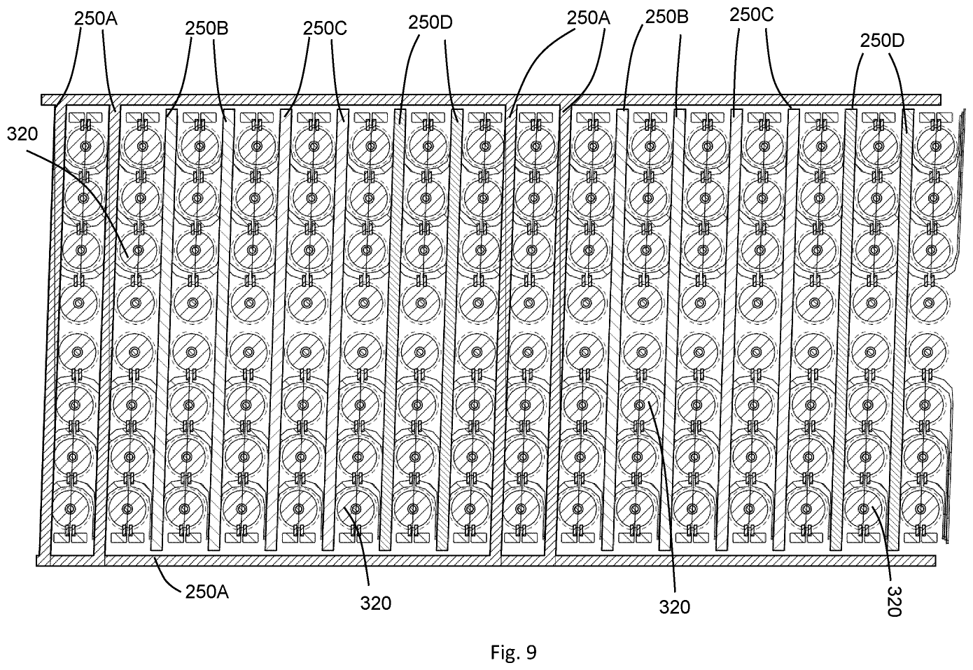

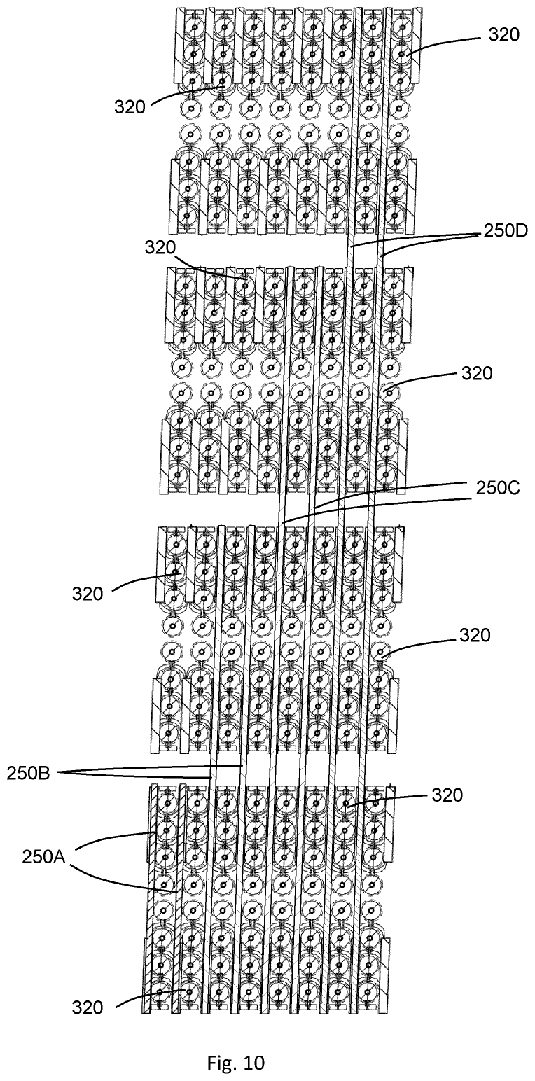

FIGS. 8 and 9 are plan views of electrical connections comprising both electrode drive conductors and actuator drive waveform conductors 250A, 250B, 250C, 250D extending across a lattice of droplet ejectors. In this example, conductors 250A conduct a first actuator drive waveform for magenta ink ejectors, conductors 250B conduct a second actuator drive waveform for blue ink ejectors and conductors 250C, 250D conduct third and fourth actuator drive waveforms for yellow and black ink ejectors respectively. Each is part of a bus which distributes the respective actuator drive waveform. The actuator drive waveform conductors can be broader than the electrode drive conductors and in this example are located above (i.e. further from the first surface of the substrate) the electrode drive conductors. In FIG. 9, only the magenta drive waveform widthwise conductors 250A are shown as connecting to lengthwise conductors running along the drive circuitry 122. As shown in plan view in FIG. 10, conductors for other channels/inks extend across the lattice of droplet ejectors, with the conductors for each channel connecting to the drive circuitry on either side of the ejectors for that channel.

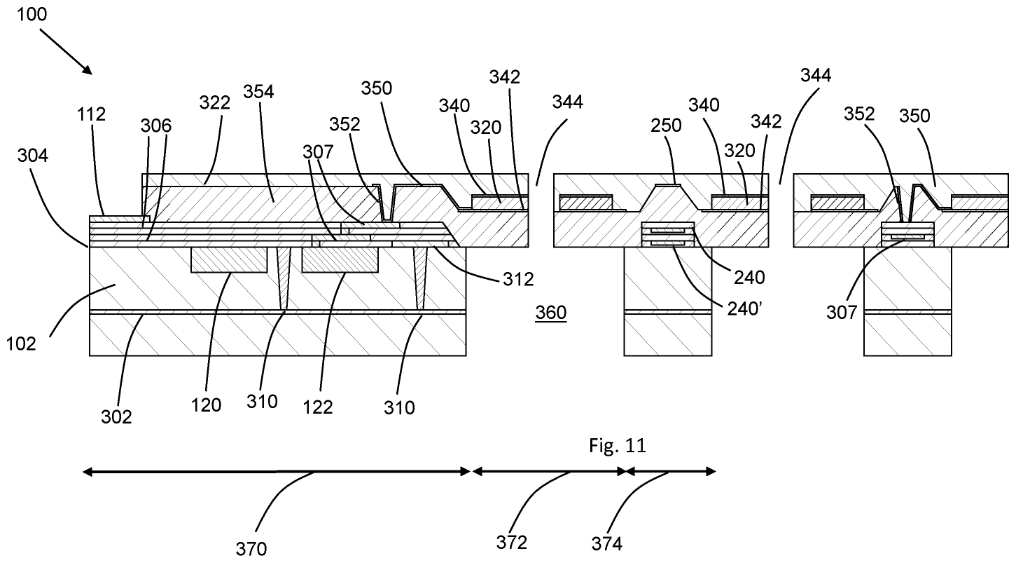

FIG. 11 is a cross-section through a printhead substrate according to the invention along a different cross section to FIG. 3. In the middle of the image, MEMS metallisation layer 250 is an actuator drive waveform conductor 250 (or one of 250A, 250B, 250C, 250D) overlying two electrode drive conductors 240, 240′ located in M3 and M1 of the CMOS metallisation layers.

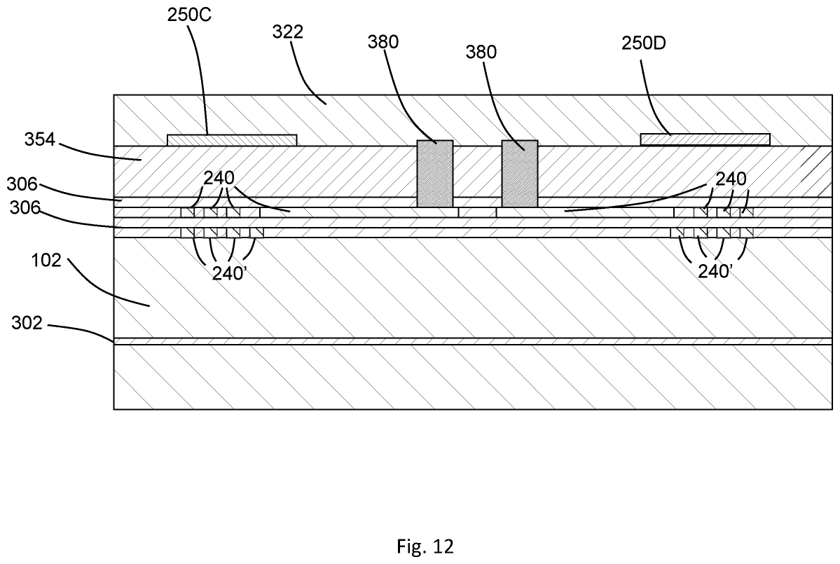

FIG. 12 is a cross-section through a printhead substrate according to FIG. 3, along a lengthwise cross-section extending between two actuator drive waveform conductors 250C, 250D (cross-section through A-A in FIG. 8). Underneath the MEMS layers 354, 322 and actuator drive waveform conductors, 250C, 250D, there are a plurality of smaller electrode drive conductors 240, 240′ located in M3 and M1 of the CMOS metallisation layers 306.

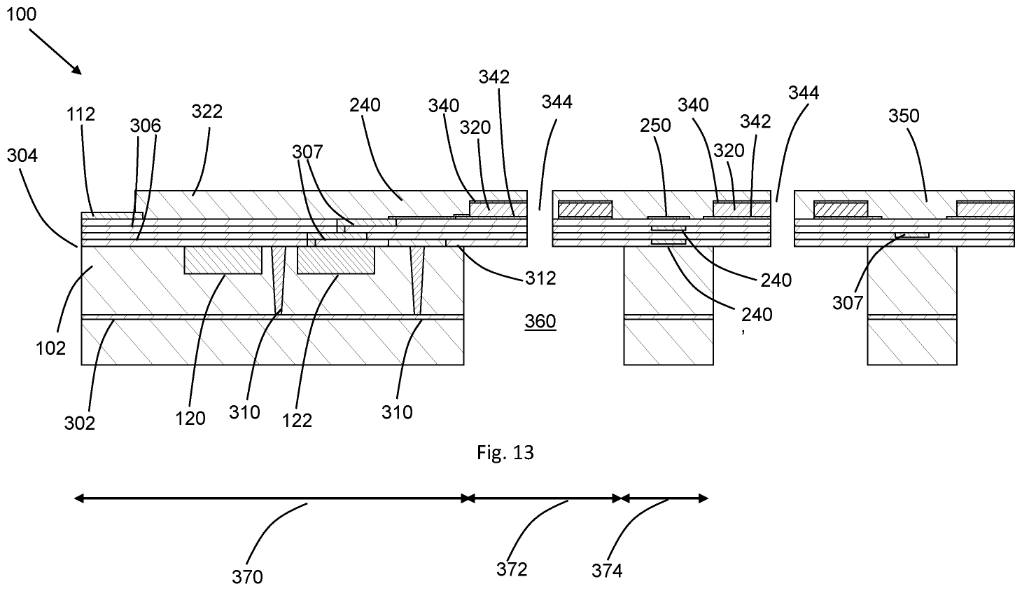

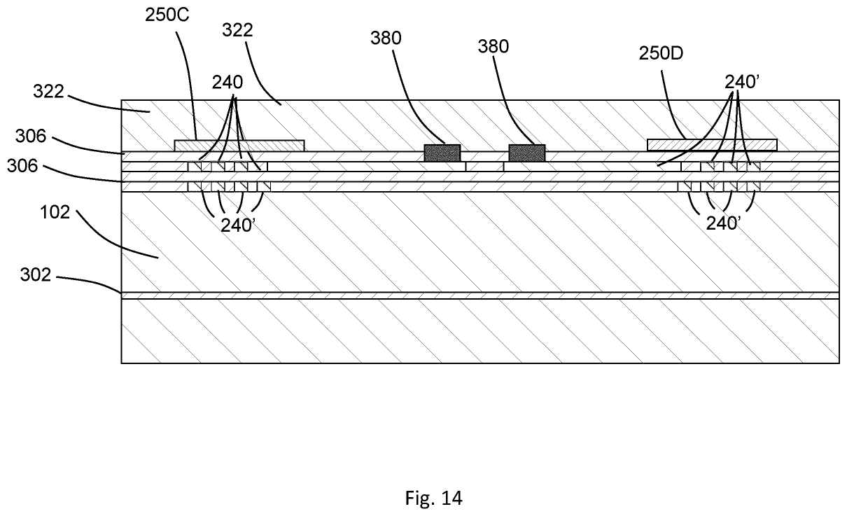

FIGS. 13 and 14 correspond to FIGS. 3 and 11 but for alternative cross-sections showing electrode drive conductors 240 connected to the lower (closer to the substrate) electrode 342 of a droplet ejector and with an actuator drive waveform conductor 250 overlying electrode drive conductors 240, 240′.

Accordingly, the electrode drive conductors 240 extend only short distances from ejection transistors and each drives only a single droplet ejector. The actuator drive waveform conductors have each to drive one or more whole zones of droplet ejectors. They may require to drive more than 100 or even more than 1000 droplet ejectors. Accordingly, they require to have a significantly larger cross section than the electrode drive conductors. They are accommodated in the MEMS metallisation layers and are broader then the electrode drive conductors in the CMOS metallisation layers. The actuator drive waveform conductors thereby extend in a grid, across zones of droplet ejectors and along CMOS drive circuitry which extend lengthwise between zones of droplet ejectors. Thus, routing of signals, and particularly the actuator drive waveform conductors, around the ends of the zones of droplet ejectors (i.e. along the short sides of the substrate) can be minimised or avoided.

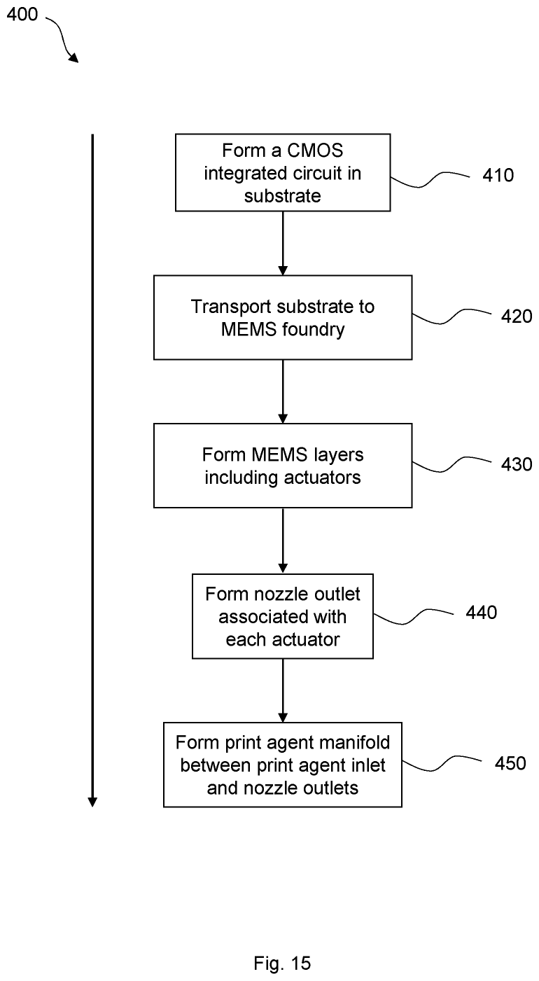

FIG. 15 shows a flowchart illustrating a method of manufacturing a printhead module. The method 400 of manufacturing a printhead module comprises forming 410 an integrated circuit (e.g. the CMOS control circuit 224 and the metal interconnect layers 306) on the substrate 102. The CMOS circuit is formed by standard CMOS processing methodologies including ion implantation on a p-type or n-type substrate and the interconnect later is also formed by standard processes such as ion implantation, chemical vapour deposition, physical vapour deposition, etching, chemical-mechanical planarization and/or electroplating.

Thereafter, the substrate with integrated CMOS circuitry is transferred 420 from a CMOS foundry to a MEMS foundry. Additional layers of material are formed on the substrate to form a MEMS device, including the electrodes 340 and 342, with an intervening piezoelectric body 320 using successive thin film deposition techniques. Thus, the method further comprises forming 430 a plurality of actuators (typically piezoelectric actuators), each to be in electrical communication with the integrated circuit. Each step must avoid damage to the CMOS control circuit. The piezoelectric body is formed of a material such as AlN or ScAlN which may be deposited at a temperature below 450° C. by PVD (including low-temperature sputtering). Electrodes are formed of, for example titanium, platinum, aluminium, tungsten or alloys thereof.

The method further comprises forming 440 a nozzle outlet 344 associated with each actuator. In other words, a plurality of nozzle outlets are formed. Each nozzle outlet is associated with a respective one of the plurality of actuators. Each nozzle outlet extends through the substrate. Typically, each nozzle outlet further extends through one or more further layers on the substrate. The method also comprises forming 450 a print agent manifold for routing print agent therethrough towards the plurality of nozzle outlets. The print agent manifold may be formed before or after the formation of the nozzle outlets. The print agent manifold may be formed before or after the formation of the plurality of actuators. The print agent manifold is a fluid channel defining a fluid communication pathway between a print agent inlet of the printhead module, and the plurality of nozzle outlets. Fluid channels and apertures through the substrate may be formed using etching procedures such as DRIE. A channel defining layer may be formed using DRIE etch and wafer bonding of silicon MEMS substrates. The nozzle defining layer can be formed of metal, silicon MEMS wafer or a plastics material by deposition on or adhesion to the channel defining later. Each droplet ejector chip is connected to the machine controller via a flexible interconnect 218 containing a limited number of conductors, typically less than 75 or fewer than 50 and potentially fewer than 25.

The material from the which the piezoelectric body is formed cannot be and is not PZT due to the requirement to avoid damaging the CMOS control circuit upon which the piezoelectric actuator, including the piezoelectric body is formed. Accordingly, the piezoelectric actuator has a piezoelectric constant d₃₁ which is much lower, usually at least one and potentially two orders of magnitude, less than PZT depending on its precise composition.

In the embodiments described above, one or more analogue actuator drive waveforms (for example one for each printable fluid type or ink colour) is generated off chip and conducted to the substrate where it is distributed through drive waveform conductors 250. In an alternative embodiment, there are instead provided a plurality of voltage rails at different potentials, for example at least three different potentials, and these extend through the substrate instead of drive waveform conductor to the drive circuitry, and the drive circuitry comprises a plurality of transistors per droplet ejector which switch which voltage rail is connect to each of the electrodes of each droplet ejector, over time, during each ejection cycle in which that droplet ejector is selected. For example, there may be a positive voltage, a negative voltage and ground which are switched in turn to provide a droplet ejection waveform.

What is claimed:

1. A printhead for ejecting one or more printable fluids, the printhead comprising a substrate;
the substrate defining a plurality of MEMS droplet ejectors for ejecting droplets of the one or more printable fluids and arranged in a lattice, each droplet ejector comprising a flexible diaphragm and a piezoelectric actuator to eject a droplet of a printable fluid through a nozzle by causing movement of the flexible diaphragm, each droplet ejector comprising at least one MEMS metallisation layer;
the substrate further defining CMOS control circuitry comprising at least one CMOS metallisation layer;
the substrate further comprising one or more of:
(i) conductive connections in at least one said metallisation layer, extending from the CMOS control circuitry to each piezoelectric actuator to actuate the piezoelectric actuators; and
(ii) conductive connections extending through the lattice in at least one said metallisation layer to conduct actuator drive waveforms.

2. A printhead according to claim 1, wherein the substrate comprises (i) conductive connections in at least one said metallisation layer, extending from the CMOS control circuitry to each piezoelectric actuator to actuate the piezoelectric actuators.

3. A printhead according to claim 2, wherein the length of the conductive connections to actuate the piezoelectric actuators, between the CMOS control circuitry and the piezoelectric actuators within a group of droplet ejectors, is consistent.

4. A printhead according to claim 2, wherein the lattice of MEMS droplet ejectors forms a droplet ejector zone of the substrate, the droplet ejector zone being elongate with a length and a width and with opposite long sides along the length, wherein the conductive connections to actuate the actuators extend into the lattice, from one or two of the opposite long sides of the droplet ejector zone, typically wherein the CMOS control circuitry comprises a plurality of drive transistors at least one of which is connected directly to at least one electrode of a piezoelectric transducer of each MEMS droplet ejector by a said conductive connection to actuate the piezoelectric actuators, without intervening transistors, wherein the plurality of drive transistors are arranged in at least one row adjacent the one or two opposite long sides of the droplet ejector zone.

5. A printhead according to claim 4, wherein the conductive connections to actuate the piezoelectric actuators extend into the lattice between rows of MEMS droplet ejectors.

6. A printhead according to claim 1, wherein (ii) conductive connections extend through the lattice in at least one said metallisation layer to conduct actuator drive waveforms, to connect the MEMS droplet ejectors to one or more sources of actuator drive waveforms.

7. A printhead according to claim 6, wherein the conductive connections connect different groups of MEMS droplet ejectors to different ones of a plurality of sources of actuator drive waveforms, to thereby relay different actuator drive waveforms to different groups of MEMS droplet ejectors.

8. A printhead according to claim 6, wherein the lattice of MEMS droplet ejectors forms a droplet ejector zone of the substrate and wherein the droplet ejector zone has a length and a width, and with opposite long sides along the length, wherein the conductive connections to conduct actuator drive waveforms extend into the lattice, from one or two of the opposite long sides of the droplet ejector zone.

9. A printhead according to claim 1, wherein each MEMS droplet ejector includes a hole through the substrate for ejection of printable fluid.

10. A printhead according to claim 1, wherein the substrate further comprises conductive connections extending through the lattice in at least one metallisation layer to connect each of the MEMS droplet ejectors to two or more different fixed voltages, wherein the CMOS control circuitry is configured to selectively connect at least one electrode of the piezoelectric actuator of the respective droplet ejector to each of a plurality of the two or more different fixed voltages in turn, responsive to control signals from the CMOS control circuitry.

11. A printhead according to claim 1 wherein, in at least a region of the substrate, the one or more MEMS metallisation layers overlie the one or more CMOS metallisation layers.

12. A printhead according to claim 1, comprising a first plurality of conductive connections and a second plurality of conductive connections, wherein the one of the first and second plurality of conductive connections comprises the conductive connections to actuate the piezoelectric actuators and the other of the first and second plurality of conductive connections comprises conductive connections to conduct droplet ejector waveforms or a plurality of different potentials, and wherein at one or more locations within the lattice, at least one first conductive connection and at least one second conductive connection both extend, but in different metallisation layers.

13. A printhead according to claim 1, wherein at one or more locations within the lattice, at least one conductive connection to actuate the piezoelectric actuators and at least one conductive connection to conduct a droplet ejector waveform, extend in parallel between the same adjacent rows of droplet ejectors.

14. A printhead according to claim 1, wherein the lattice comprises at least a first, a second and a third row of MEMS droplet ejectors wherein a plurality of conductive connections extend between droplet ejectors of the first and second row to different respective droplet ejectors along the length of the second row.

15. A printhead according to claim 14, wherein a plurality of conductive connections extend between droplet ejectors of the second and third row to different respective droplet ejectors along the length of the second row.

16. A printhead according to one preceding claim 1, wherein the CMOS control circuitry comprises one or more first zones and one or more second zones, wherein the substrate comprises one or more isolation features separating the first and second zones, wherein the one or more first zones comprise transistors which process digital signals and the one or more second zones comprise drive transistors which provide potentials directly to electrodes of piezoelectric actuators, wherein the second zone operates at at least double the maximum potential of the first zone.

17. A printhead according to claim 1, wherein the substrate defines a plurality of adjacent droplet ejector zones which are elongate having a length and a width and which are spaced apart orthogonally to their length, wherein between each adjacent droplet ejector zone there is provided at least one CMOS circuitry zone which is also elongate and aligned in the same orientation as the droplet ejectors zones, the CMOS circuitry zone including at least one CMOS metallisation layer, wherein conductive connections extend from the CMOS circuitry into adjacent droplet ejector zones to actuate piezoelectric actuators; and optionally, wherein the at least one CMOS circuitry zone comprises both a higher and a lower voltage region, the lower voltage region comprising one or more digital logic gates, the higher voltage region comprising ejection transistors which are directly connected to piezoelectric transducers of respective droplet ejectors, and wherein the higher and lower voltage regions are separate by an isolation feature in the substrate, typically wherein one or more conductive connections for actuator drive waveforms extend widthwise across one or more droplet ejector zones and connect to a higher voltage region of a CMOS circuitry zone.

18. (canceled)

19. A printhead according to claim 1, comprising a plurality of bond pads in a discrete zone of the substrate.

20. A printing apparatus comprising a printhead according to claim 1.

21. A method of forming a printhead or printing apparatus according to claim 1, comprising the steps of:
forming a lattice of apertures through a substrate, each aperture to at least in part define a fluid chamber of a droplet ejector;
forming the CMOS control circuitry, including at least one CMOS metallisation layer, on a first surface of the substrate;
forming a MEMS layer, comprising flexible diaphragms, piezoelectric actuators and at least one MEMS metallisation layer, on the first substrate of the substrate, to thereby form the plurality of droplet ejectors;
whereby each droplet ejector is conductively connected to the CMOS control circuitry through at least one said metallisation layer.
